(19) United States
(12) Patent Application Publication
(10) Pub. No.: US 2019/0114351 A1
(43) Pub. Date: Apr. 18, 2019

(54) ENHANCING THE READABILITY OF A HEATMAP THAT VISUALLY REPRESENTS TIME SERIES DATA

(71) Applicant: Microsoft Technology Licensing, LLC, Redmond, WA (US)

(72) Inventors: Alexandre Igorevich MINEEV, Kenmore, WA (US); Matthew Robert DARSNEY, Seattle, WA (US); Dmitry DENISOV, Bellevue, WA (US); Om Prakash RAVI, Sammamish, WA (US)

(21) Appl. No.: 15/782,346

(22) Filed: Oct. 12, 2017

(51) Int. Cl. G06F 17/30; G06F 17/18

(52) U.S. Cl. CPC G06F 17/30572; G06F 17/30601; G06F 17/18

(57) ABSTRACT

A method for improving readability of a heatmap representing time series data may include obtaining a set of time series. Each time series may be associated with a key property and may include a set of values. The set of values in a time series may include results of performing an aggregate function with respect to a measure property in events that are associated with the key property, and at time intervals having an interval size. For each time series, an average value may be determined for the set of values within the time series. A heatmap may be rendered based on the set of time series. The set of time series may be ordered vertically in the heatmap based on the set of average values that are determined for the set of time series.

### CROSS-REFERENCE TO RELATED APPLICATIONS

N/A

### BACKGROUND

Time series data is used in a wide variety of industries for many different purposes. For example, the growth of low-cost and reliable sensor technology has led to the spread of data collection across all sorts of monitored devices, including machinery, cellular phones, engines, vehicles, turbines, appliances, medical telemetry, industrial process plants, and so forth. This sensor data is time series data because it takes the shape of a value or set of values with a corresponding timestamp, or temporal ordering. As another example, modern electronic devices (such as personal computers, smartphones, tablets, and other personal electronic devices) allow significant amounts of data to be captured, often as time series data. This data may include operational data, logs, journals, or the like.

A time series produced by an entity provides information about the states and behavior of that entity. The time series produced by various entities may be analyzed in order to learn and understand more about those entities. By analyzing time series data, entities may be compared to each other and to themselves across time.

Analyzing time series data, however, has proven challenging. This is particularly true for time series data corresponding to a large number of different time series. For example, if time series data is collected from thousands of different devices (such that there are thousands of different time series), the amount of data involved can make it difficult to perform any type of meaningful analysis on that data. Also, the storage mechanisms used for time series data are typically not designed for the convenience of users who are unskilled in the use of database systems.

### SUMMARY

A method for improving readability of a heatmap representing time series data is disclosed. The method may include obtaining a set of time series. Each time series may be associated with a key property and may include a set of values. The set of values in a time series may include results of performing an aggregate function with respect to a measure property in events that are associated with the key property, and at time intervals having an interval size. The method may also include determining, for each time series, an average value for the set of values within the time series, such that a set of average values is determined for the set of time series. A heatmap may be rendered based on the set of time series. The set of time series may be ordered vertically in the heatmap based on the set of average values that is determined for the set of time series.

The method may also include providing a query that includes the key property, the measure property, the aggregate function, and the time interval. The key property, the measure property, the aggregate function, and the time interval may be received via user input. In some implementations, the query may additionally include a filter, which may also be received via user input. The set of time series may be received in response to the query.

The heatmap may include multiple rows, multiple columns, and multiple cells. Each cell may correspond to an intersection of a row and a column. Each row of the heatmap may correspond to a particular time series, and each column of the heatmap may correspond to a particular time interval. A color of a cell in the heatmap may be based on a result of performing the aggregate function with respect to the measure property in the events that are associated with the key property and that have a timestamp within a time interval of the cell.

A single average value may be calculated for each time series. The single average value may be calculated across the set of values in the time series comprising the results of performing the aggregate function with respect to the measure property in the events that are associated with the key property, and at the time intervals having the interval size. A vertical position of a time series in the heatmap may depend on the average value that is calculated for the time series. For example, the set of time series may be ordered in the heatmap in descending order from a time series having a highest average value to a time series having a lowest average value. Alternatively, the set of time series may be ordered in the heatmap in ascending order from a time series having a lowest average value to a time series having a highest average value.

The set of time series may include multiple time series. Each time series within the set of multiple time series may be associated with a unique value for the key property.

A computer system for improving readability of a heatmap representing time series data is also disclosed. The computer system may include one or more processors and memory comprising instructions that are executable by the one or more processors to perform certain operations. The operations may include obtaining a set of time series. Each time series may be associated with a key property and may include a set of values. The set of values in a time series may include results of performing an aggregate function with respect to a measure property in events that are associated with the key property, and at time intervals having an interval size. The operations may also include determining, for each time series, an average value for the set of values within the time series, such that a set of average values is determined for the set of time series. A heatmap may be rendered based on the set of time series. The set of time series may be ordered vertically in the heatmap based on the set of average values that is determined for the set of time series.

A computer-readable medium having computer-executable instructions stored thereon is also disclosed. When executed, the instructions cause one or more processors to perform certain operations. The operations may include obtaining a set of time series. Each time series may be associated with a key property and may include a set of values. The set of values in a time series may include results of performing an aggregate function with respect to a measure property in events that are associated with the key property, and at time intervals having an interval size. The operations may also include determining, for each time series, an average value for the set of values within the time series, such that a set of average values is determined for the set of time series. A heatmap may be rendered based on the set of time series. The set of time series may be ordered vertically in the heatmap based on the set of average values that is determined for the set of time series.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Additional features and advantages of implementations of the disclosure will be set forth in the description that follows, and in part will be apparent from the description, or may be learned by the practice of the teachings herein. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, similar reference numbers have been used for similar features in the various embodiments. Unless indicated otherwise, these similar features may have the same or similar attributes and serve the same or similar functions. Understanding that the drawings depict some examples of embodiments, the embodiments will be described and explained with additional specificity and detail through the use of the accompanying drawings in which:

FIG. 1 illustrates a system in which aspects of the present disclosure may be utilized.

FIG. 2 illustrates an example of a table that may be created to store events received from devices.

FIG. 3 illustrates an example of a heatmap that represents a set of time series, in which the time series are ordered in accordance with the techniques disclosed herein.

FIG. 4 illustrates an example of a heatmap that represents a set of time series, in which the time series are not ordered in accordance with the techniques disclosed herein.

FIG. 5A illustrates another example of a heatmap that represents a set of time series, in which the set of time series are ordered in accordance with the techniques disclosed herein.

FIG. 5B illustrates another example of a heatmap that represents a set of time series, in which the set of time series are not ordered in accordance with the techniques disclosed herein.

FIGS. 6A-6D illustrate an example for improving the readability of a heatmap in accordance with the present disclosure.

FIG. 7 is a flow diagram that illustrates an example of a method for improving the readability of a heatmap in accordance with the present disclosure.

FIG. 8 illustrates certain components that may be included within a computer system.

### DETAILED DESCRIPTION

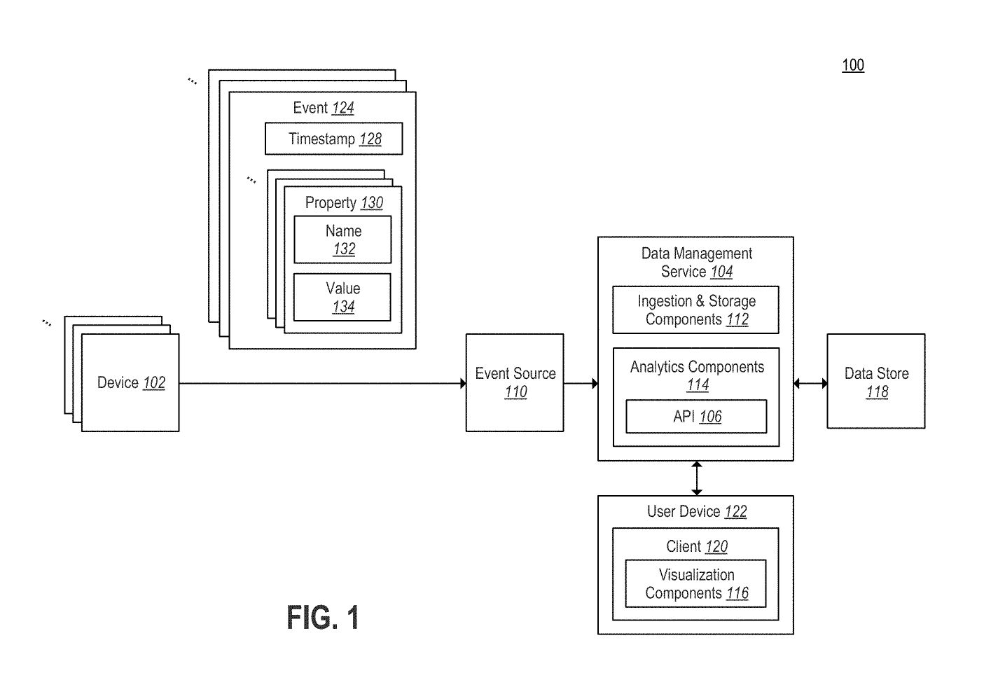

FIG. 1 illustrates a system 100 in which aspects of the present disclosure may be utilized. The system 100 may include devices 102 that output time series data. There are many different types of devices 102 from which time series data may be collected or generated. Some examples include sensors, industrial assets, Internet of Things (IoT) devices, consumer electronic devices, mobile devices, mobile apps, web servers, application servers, databases, firewalls, routers, operating systems, and software applications that execute on computer systems.

Some devices 102 may output time series data on a periodic basis. For example, sensors may produce telemetry data every few minutes. Alternatively, time series data may be output in response to particular actions, which may not necessarily occur periodically. For example, mobile apps may capture and report data in response to particular actions taken by customers.

The data output by a particular device 102 may be structured as a stream of events 124. An event 124 may include a timestamp 128. The timestamp 128 corresponding to a particular event 124 may identify the date and time at which the event 124 was generated. An event 124 may also include one or more name-value pairs. Each name-value pair may correspond to a property 130 of the event 124. Thus, a property 130 may include a name 132 and a value 134.

Devices 102 may send streams of events 124 to an event source 110. A data management service (DMS) 104 may read the events 124 from the event source 110. In some embodiments, the DMS 104 may receive events 124 in JavaScript Object Notation (JSON) format. Alternatively, events 124 may be received in a different format, such as comma separated values (CSV) format. The following is an example of an event 124 in JSON format:

{
“id”:“EH123”,
“timestamp”:“2016-01-08T07:03:00Z”,
“data”:{

“type”:“pressure”,
“units”:“psi”,
“measurement”:108.09

}
}

In this example, the identifier “EH123” identifies the event source 110. The timestamp 128 is 2016-01-08T07:03:00Z (i.e., 7:03 a.m. on Jan. 8, 2016). There are three properties 130: a first property 130 having the name 132 equal to “type” and the value 134 equal to “pressure”, a second property 130 having the name 132 equal to “units” and the value 134 equal to “psi”, and a third property 130 having the name 132 equal to “measurement” and the value 134 equal to the number 108.09.

The DMS 104 may include components for processing the events 124. For example, the DMS 104 may include ingestion and storage components 112 and analytics components 114. The ingestion and storage components 112 may be configured to receive and process large numbers of events 124 (e.g., millions of events 124 per second) from one or more event sources 110. These events 124 may be stored in a data store 118. The analytics components 114 may make various aspects of the events 124 available for users to query via an application programming interface (API) 106.

Communication between the event source(s) 110 and the DMS 104 may occur via one or more computer networks. In some embodiments, the DMS 104 may be implemented as a cloud computing service, and communication between the event source(s) 110 and the DMS 104 may occur via the Internet. Alternatively, the DMS 104 may be implemented as another type of application other than a cloud computing service, and communication between the event source(s) 110 and the DMS 104 may not necessarily require access to the Internet. For example, communication between the event source(s) 110 and the DMS 104 may occur via a local area network (LAN) or wireless LAN. Alternatively still, the event source(s) 110 and the DMS 104 may exist on the same computing device. For example, the DMS 104 may be implemented as a log-processing system that runs on a particular computing device and collects logs produced by an operating system of the computing device.

Users may access information about particular events 124 via a client 120 running on a user device 122, such as a personal computer, laptop computer, mobile device, or the like. The client 120 may be a web browser that accesses the DMS 104 via the Internet. Alternatively, the client 120 may be another type of software application other than a web browser. The client 120 may communicate with the API 106 in order to make queries with respect to the events 124. The client 120 may include visualization components 116 that provide visual representations of various aspects of the events 124 based on queries made via the API 106.

Events 124 stored by the DMS 104 may be partitioned into one or more environments. Different environments may correspond to different users. Under some circumstances, a single user may create multiple environments in order to keep unrelated events 124 separate from one another. For example, a user may create different environments for different sites where devices 102 are located (e.g., different factories).

There are many ways in which the events 124 that the DMS 104 receives from event sources 110 may be analyzed and used. For example, a human operator may use a client 120 running on a user device 122 to interact with the DMS 104 in order to monitor the current state and history of various devices 102. If the operator determines that something interesting is happening with one or more devices 102, the operator can use the DMS 104 to take various actions (e.g., analyze the history of the devices 102, compare one device 102 to another, compare one time frame to another for the same device 102) to understand what is happening and what corrective action needs to be taken with respect to the devices 102. Alternatively, instead of a human operator interacting with the DMS 104, another computer system may interact with the DMS 104 in order to identify problems (via machine learning techniques, for example) and take corrective action.

It can, however, be difficult for users to identify relevant information that is contained within stored events 124. There are at least two sources of difficulty. First, there may be a very large number of devices 102 (e.g., thousands of devices 102) producing events 124. Second, each device 102 may produce a very large number of events 124. Therefore, a voluminous amount of data may be collected and stored, and it may be difficult for users to be able to identify patterns or anomalies in such a large amount of data. It may also be difficult for users to be able to describe their data in a meaningful way. This is particularly true for users who lack training in statistical analysis or database management.

Under some circumstances, the visualization components 116 may generate one or more visual representations corresponding to aspects of events 124 that have been received and stored. One example of such a visual representation is a heatmap. In a heatmap, the values of individual and specific data points are identified by allocating a specific color based on the data point value. For example, red may indicate that the data point value is high, and blue may indicate that the data point value is low. The color spectrum in between red and blue may then be used to indicate the interim values of other data points.

A heatmap may be used to represent time series data. As will be discussed in greater detail below, a heatmap may include multiple rows, multiple columns, and multiple cells. Each row of the heatmap may correspond to a particular time series. As used herein, the term “time series” refers generally to any set of values wherein each value is associated with a particular point in time, or timestamp. Each column of the heatmap may correspond to a particular time interval. Each cell within the heatmap corresponds to an intersection of a row and a column. Thus, each cell may represent a particular time series and a particular time interval.

Heatmaps that represent a large number of time series (e.g., hundreds or thousands of time series) may not be easy for human users (or machines, via machine learning) to read. In accordance with the present disclosure, however, the readability of a heatmap may be improved by ordering the time series that are represented in the heatmap. Examples of techniques for ordering the time series will be described below. Improving the readability of a heatmap may make it easier for users to identify relevant information in a large number of time series. For example, users may be able to identify anomalies more quickly and easily as a result of the techniques disclosed herein.

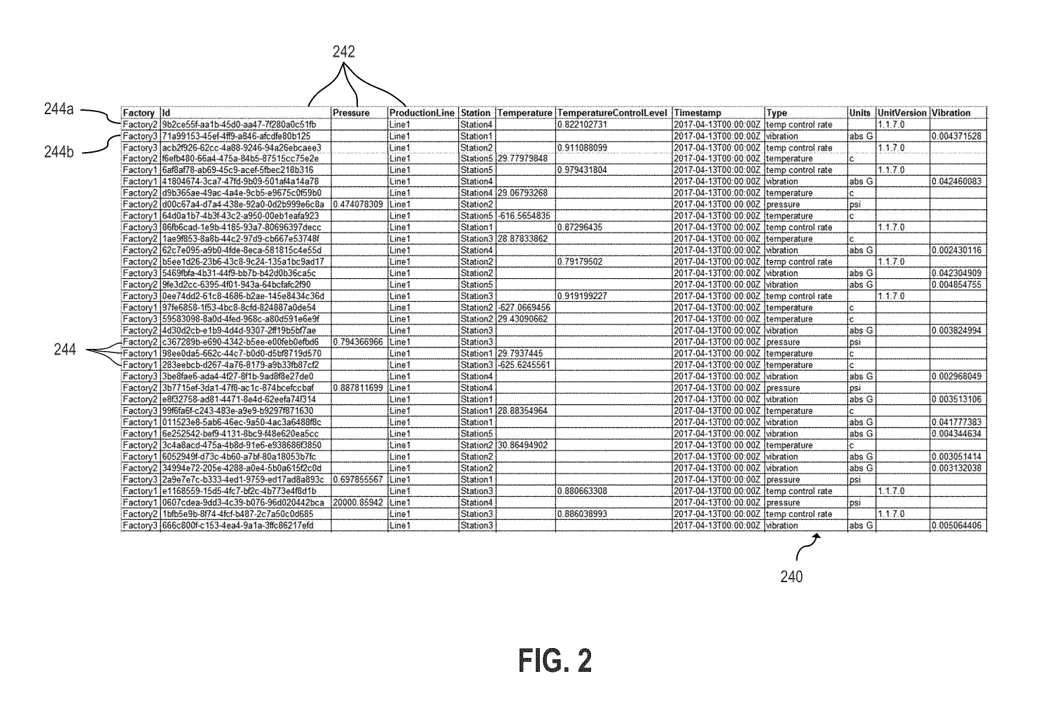

FIG. 2 illustrates an example of a table 240 that may be created to store events 124 received from devices 102, via event sources 110. The table 240 includes multiple columns 242 corresponding to different properties 130 in received events 124. Each row 244 in the table 240 may correspond to a separate event 124.

Some of the fields within the table 240 do not include any values (or, stated another way, they include null values). This is because different events 124 may include different combinations of properties 130. For example, the event 124 that is represented by the first row 244a in the table 240 includes the following properties 130: Factory, Id, ProductionLine, Station, TemperatureControlLevel, Timestamp, Type, and UnitVersion. The event 124 that is represented by the second row 244b in the table 240, however, includes a different combination of properties 130: Factory, Id, ProductionLine, Station, Timestamp, Type, Units, and Vibration.

For the sake of simplicity, the table 240 shown in FIG. 2 only includes data from a few events 124, and the events 124 only include a few properties 130. In practice, however, a DMS 104 in accordance with the present disclosure may be capable of receiving and storing information about large numbers of events 124 (e.g., billions of events 124) from large numbers of devices 102 (e.g., thousands of devices 102) via one or more event sources 110.

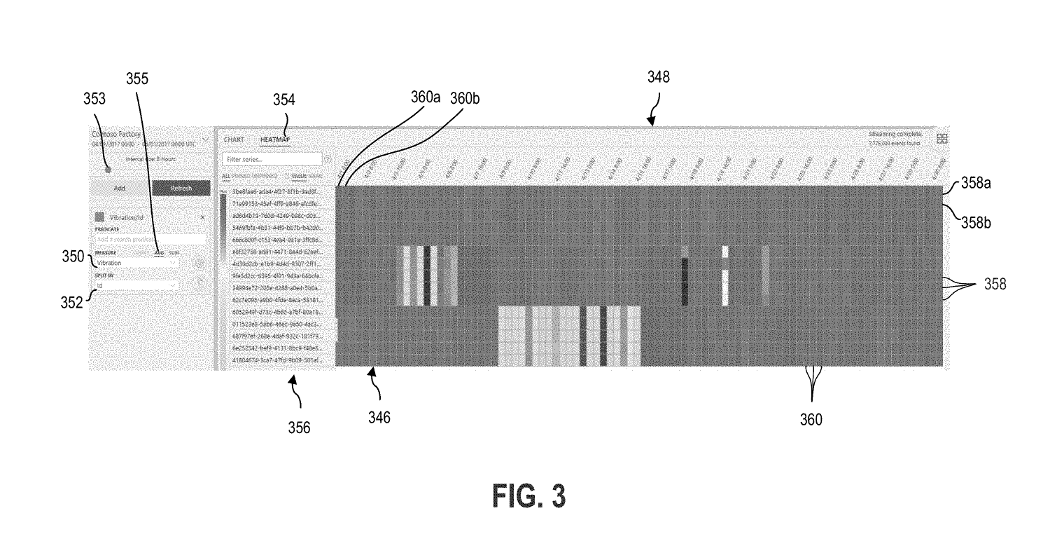

FIG. 3 illustrates an example of a heatmap 346 that may be displayed by a DMS 104. The heatmap 346 is shown in a user interface screen 348 (e.g., a web page). The user interface screen 348 includes several user interface components that enable the user to provide relevant input for creating the heatmap 346. For example, the user interface screen 348 includes a pull-down menu 352 that enables the user to identify a property 130 to be used as a unique key for the time series that are represented in the heatmap 346. The user interface screen 348 also includes a pull-down menu 350 that enables the user to identify a property 130 (e.g., vibration) to be represented in the time series. The user interface screen 348 also includes a scroll button 353 that enables the user to specify the size of the time interval for each column of the heatmap 346. The user interface screen 348 also includes an option 355 that enables the user to specify an aggregate function (e.g., finding an average value) that is to be performed in order to create the heatmap 346. The content of the user input, and how it may be used to create a heatmap 346, will be discussed in greater detail below. The user interface screen 348 also includes an option 354 that may be selected by a user in order to cause the heatmap 346 to be created and displayed.

In the depicted example, the property 130 that is used as a unique key for the time series that are represented in the heatmap 346 is device identifier. The user interface screen 348 includes a list 356 of device identifiers. The heatmap 346 includes multiple rows 358, and each row 358 corresponds to a different time series. Each time series corresponds to a particular device 102, and is uniquely identified by a particular device identifier. For example, the first row 358a in the heatmap 346 corresponds to a time series from a device 102 that is identified by the first device identifier in the list 356, the second row 358b in the heatmap 346 corresponds to a time series from a device 102 that is identified by the second device identifier in the list 356, and so forth.

The heatmap 346 also includes multiple columns 360. The heatmap 346 represents time series corresponding to events 124 that were received during a particular period of time (e.g., from Apr. 1, 2017 to May 1, 2017). Each column 360 corresponds to a time interval within that overall period of time (e.g., 8 hours). For example, the first column 360a may correspond to a time interval between Apr. 1, 2017, at midnight until Apr. 1, 2017, at 8:00 a.m., the second column 360b may correspond to a time interval between Apr. 1, 2017, at 8:00 a.m. until Apr. 1, 2017, at 4:00 p.m., and so forth.

As noted above, the intersection of a row 358 and a column 360 of the heatmap 346 may be referred to as a cell. In the heatmap 346, each cell is displayed as a particular color. The color that is displayed for a particular cell may be determined by mapping the values that correspond to the row 358 (i.e., a particular time series) and the column 360 (i.e., a particular time interval) to a single value, and then assigning that value to a particular color. This will be described in greater detail below.

The heatmap 346 shown in FIG. 3 is rendered in such a way that it is relatively straightforward to read, either by a human or by a machine (via machine learning, for example). Time series with similar ranges of values are shown close to each other, which allows common trends (e.g., increasing or decreasing values, dips and spikes, periodicity) to be easily identified. Thus, it is relatively straightforward to identify anomalies and to spot patterns of common behavior across different time series (which, in the present example, correspond to different devices 102).

To make the heatmap 346 easier to read, as in FIG. 3, the different time series that are represented in the heatmap 346 are ordered in a particular way. Techniques for ordering the time series will be described below.

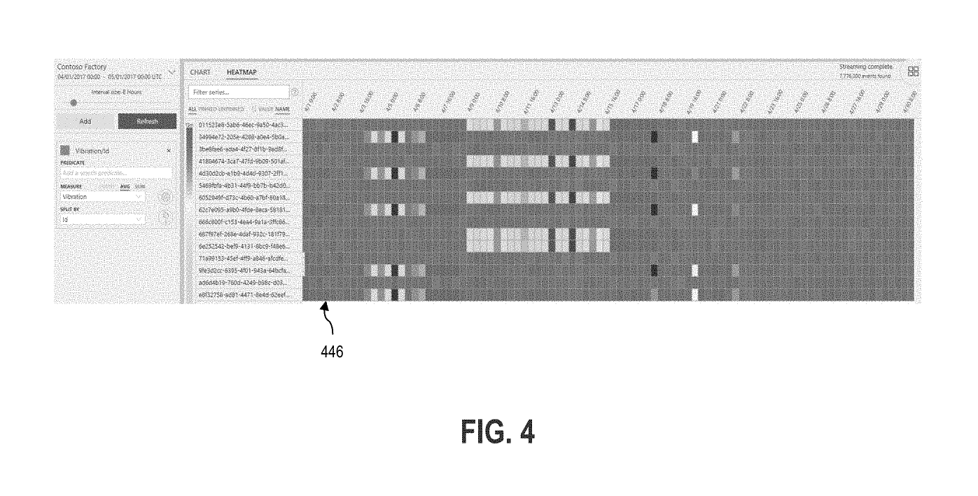

To see the benefit of ordering the time series, it is useful to compare the heatmap 346 shown in FIG. 3 with another heatmap 446, shown in FIG. 4, in which the time series are not ordered in any particular way but are instead arranged randomly. As can be seen, the heatmap 446 shown in FIG. 4 is not nearly as readable as the heatmap 346 that is shown in FIG. 3. In the heatmap 446 shown in FIG. 4, no effort is made to show time series with similar ranges of values close to each other. As a result, it is difficult for a user to identify anomalies or to spot patterns of common behavior across different time series (e.g., different devices 102).

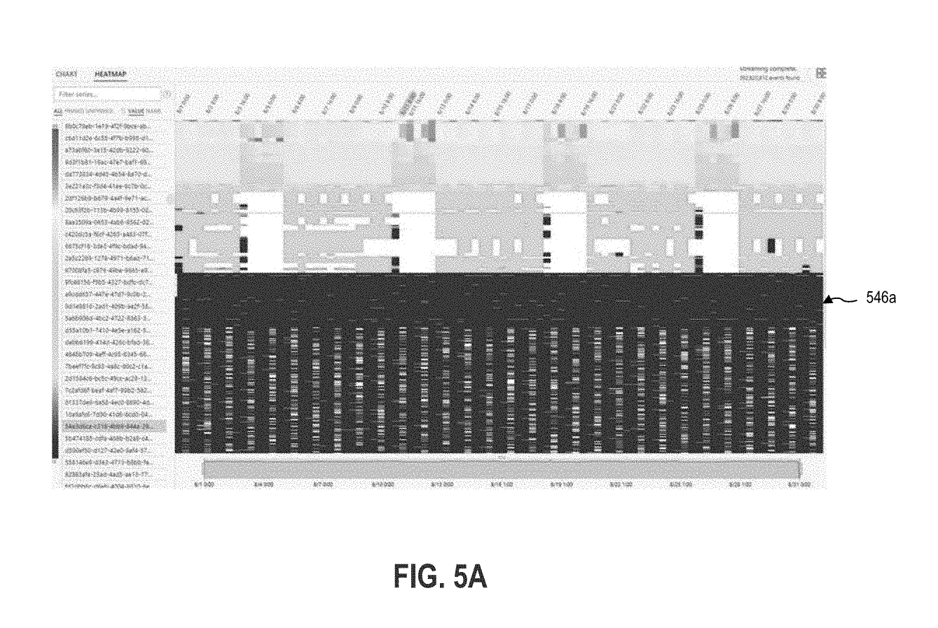

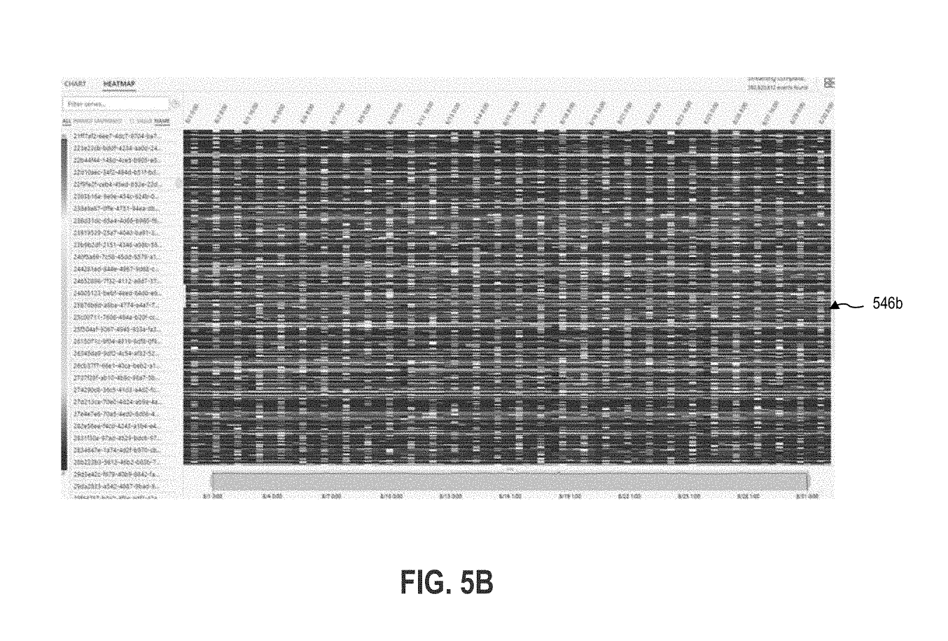

The examples shown in FIGS. 3 and 4 are somewhat simplified because they only include a relatively small number of time series. FIGS. 5A and 5B illustrate other examples of heatmaps 546a, 546b that represent large numbers of time series (e.g., hundreds of time series). In other words, the examples shown in FIGS. 5A and 5B represent high-dimensional data. FIG. 5A is an example of a heatmap 546a in which the different time series are ordered in accordance with the techniques disclosed herein. By contrast, FIG. 5B is an example of a heatmap 546b in which the different time series are not ordered in any particular way, but are instead arranged randomly. As these examples clearly demonstrate, ordering the time series makes the resulting heatmap 546a much easier to read. It is difficult to discern any meaningful information from the heatmap 546b shown in FIG. 5B, but it is relatively straightforward to identify anomalies and to spot patterns of common behavior across different time series (e.g., devices 102) in the heatmap 546a shown in FIG. 5A.

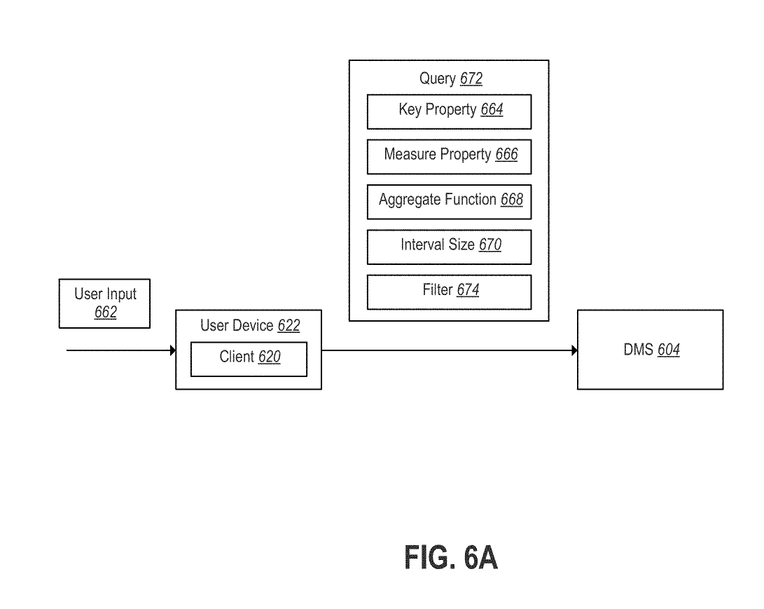

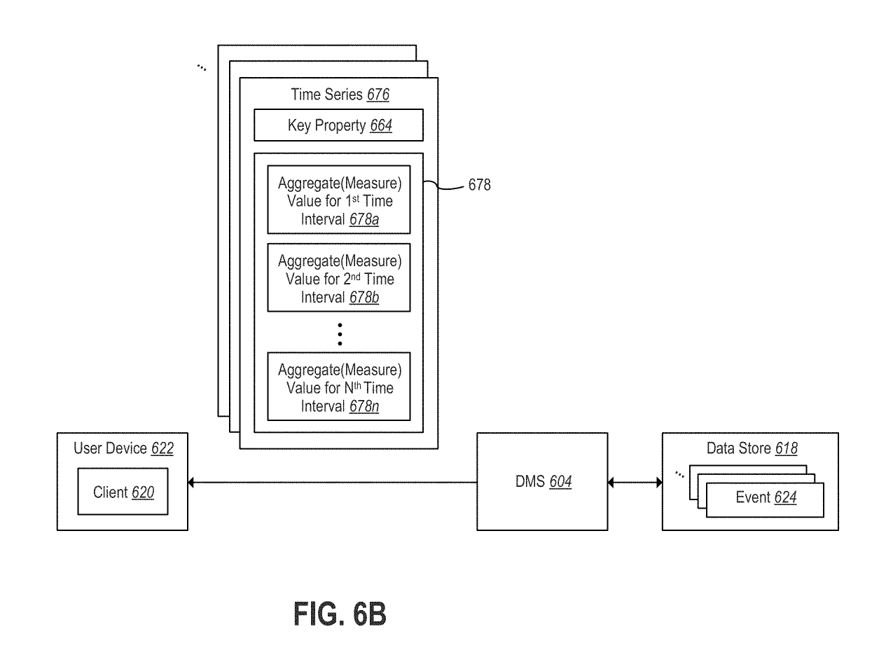

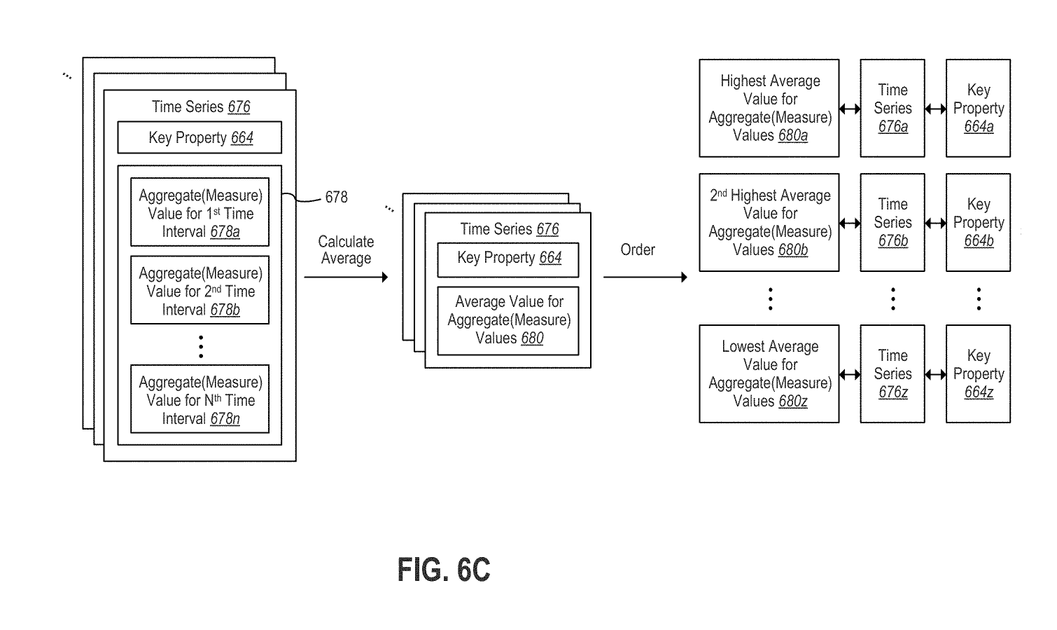

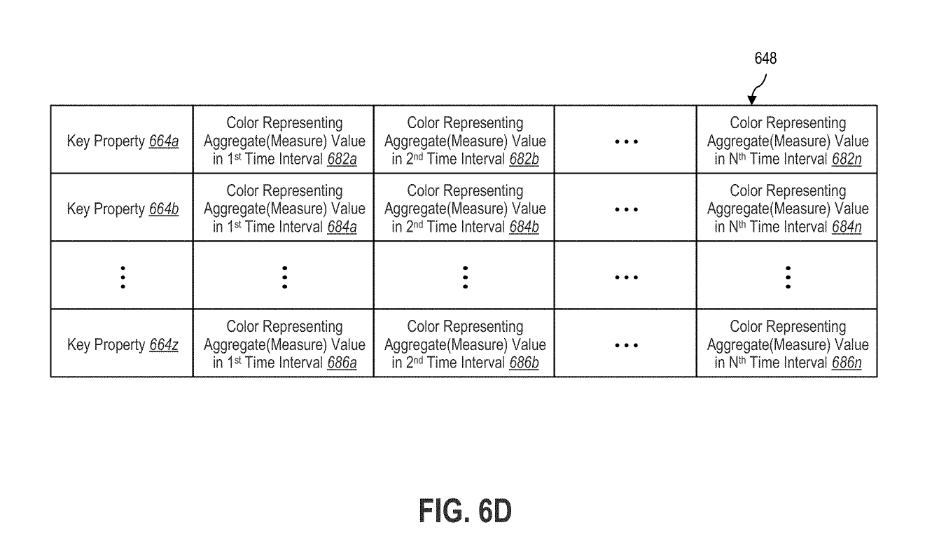

FIGS. 6A-6D illustrate an example for improving the readability of a heatmap 648 in accordance with the present disclosure. Reference is initially made to FIG. 6A, which shows user input 662 being provided to a client 620 running on a user device 622. A user may specify, via the user input 662, several parameters that may be used in a query 672 to the DMS 604. These parameters may include a key property 664, a measure property 666, an aggregate function 668, and an interval size 670.

The key property 664 may be any property 130 within events 124 that can uniquely identify a time series. Some examples of key properties 664 include a device identifier, a factory identifier, a station identifier, a production line identifier, a device type, and a unit version. These are just a few examples, however, and should not be interpreted as limiting the scope of the present disclosure. There are many different types of properties 130 that can be used as key properties 664 in accordance with the present disclosure. In the user interface screen 348 shown in FIG. 3, the key property 664 may be selected via the pull-down menu 352 that is labeled “Split By”.

The measure property 666 may be any property 130 within events 124 whose value changes over time. One example of a measure property 666 is a property 130 that represents a physical measurement, like temperature or pressure. Another example of a measure property 666 is the number of events 124. Again, however, these examples should not be interpreted as limiting the scope of the present disclosure. There are many different types of properties 130 that can be used as a measure property 666 in accordance with the present disclosure. In the user interface screen 348 shown in FIG. 3, the measure property 666 may be selected via the pull-down menu 350 that is labeled “Measure”.

The aggregate function 668 is a function that performs some operation on a set of values. Some examples of aggregate functions 668 include finding the average of a set of values, finding the maximum of a set of values, finding the minimum of a set of values, finding the median of a set of values, and counting the number of values within a set of values. Again, however, this list of examples is not intended to be exhaustive, and other types of aggregate functions 668 may be used in accordance with the present disclosure. In the user interface screen 348 shown in FIG. 3, the user may select the option corresponding to the desired aggregate function 668 (e.g., the option 355 labeled “AVG” for the aggregate function 668 of finding the average value).

The interval size 670 indicates the size of a time interval. More specifically, the interval size 670 indicates the size of the time interval over which the aggregate function 668 should be performed with respect to the measure property 666 in events 124 that are associated with the key property 664. In other words, the interval size 670 indicates the size of the time interval corresponding to a particular column 360 of the heatmap 648. For example, suppose that the measure property 666 is temperature and the aggregate function 668 is to find the average value. In this example, the interval size 670 indicates the size of the time intervals over which the average temperature should be calculated. For example, if the interval size 670 is one minute, this means that the average temperature should be calculated for each one-minute time interval in events 124 that are associated with the key property 664.

The user input 662 may also provide a filter 674. The filter 674, which is optional, may further limit the results of the query 672. The filter 674 may, for example, limit the results that are returned from the query 672 to particular values 134 or ranges of values 134 for the measure property 666.

In response to the user input 662, a query 672 with the specified parameters is submitted to the DMS 604. Referring now to FIG. 6B, the DMS 604 runs the query 672 against events 624 in the data store 618 and returns one or more time series 676. Each time series 676 corresponds to a unique key property 664 and includes a set of values 678.

For example, suppose that the key property 664 is a device identifier. In this example, if there are N unique device identifiers among the stored events 624, then the query 672 will return N time series 676. In addition, each time series 676 will be identified by its device identifier (which is the value of its key property 664 in this example), such as device1, device2, . . . deviceN. Thus, each time series 676 is associated with a unique value for the key property 664.

As shown in FIG. 6B, a time series 676 includes a set of multiple values 678. The set of values 678 within a time series 676 includes the results of performing the specified aggregate function 668 with respect to the measure property 666 in events 624 that are associated with the key property 664, and at time intervals having the specified interval size 670. More specifically, the set of values 678 within a time series 676 includes a first value 678a corresponding to the result of performing the specified aggregate function 668 with respect to the measure property 666 in events 624 that are associated with the key property 664 and that have a timestamp 128 within a first time interval, a second value 678b corresponding to the result of performing the specified aggregate function 668 with respect to the measure property 666 in events 624 that are associated with the key property 664 and that have a timestamp 128 within a second time interval, and so on. FIG. 6B also shows an Nth value 678n corresponding to the result of performing the specified aggregate function 668 with respect to the measure property 666 in events 624 that are associated with the key property 664 and that have a timestamp 128 within an Nth time interval.

The values 678a, 678b, . . . 678n in a time series 676 may be referred to herein as aggregate(measure) values 678a, 678b, . . . 678n, to indicate that these values 678a, 678b, . . . 678n are the result of performing the specified aggregate function 668 with respect to the measure property 666. For a particular time interval, a time series 676 includes a single aggregate(measure) value 678. A time series 676 corresponds to multiple time intervals, and therefore includes multiple aggregate(measure) values 678a, 678b, . . . 678n. In other words, as discussed above, a time series 676 corresponds to a row 358 of a heatmap 648, which includes multiple cells. A time series 676 includes a single aggregate(measure) value 678 for each cell. For the entire row 358 (which spans multiple time intervals), the time series 676 includes multiple aggregate(measure) values 678a, 678b, . . . 678n.

Consider a specific example. Suppose that user input 662 is received in which the key property 664 is a device identifier, the measure property 666 is temperature, the aggregate function 668 is finding the average value, and the interval size 670 is one minute. In this example, assuming that the DMS 604 has been storing events 624 from multiple devices 102, the query 672 returns a set of multiple time series 676. Each time series 676 in the set corresponds to the events 624 output by a particular device 102. Moreover, each time series 676 in this example is a set of average temperature values calculated over a one-minute time interval with respect to a particular device 102.

Suppose, for instance, that the data store 618 includes events 624 corresponding to 1,000 devices for one day. In this case, the query 672 would return 1,000 time series, and each time series would include 1,440 values (the average temperature per minute for each minute of the day). If the data store 618 includes events 624 corresponding to 1,000 devices for 30 days, then the query 672 would still return 1,000 time series, but each time series would include 43,200 values (the average temperature per minute for each minute of a 30-day time period).

Reference is now made to FIG. 6C. The system (meaning the client 620, the DMS 604, or a combination thereof) uses the set of time series 676 obtained from the query 672 to render a heatmap 648 (which is represented in FIG. 6D in the form of a block diagram). As noted above, each time series 676 corresponds to a particular row 358 of the heatmap 648. To order the set of time series 676 vertically in the heatmap 648, the system maps each time series 676 to a single number, and then orders the set of time series 676 by that number. More specifically, the system calculates, for each time series 676, an average value 680 for all of the aggregate(measure) values 678 in the time series 676. Then, the system orders the set of time series 676 vertically in the heatmap 648 based on this average value 680.

Consider one of the examples discussed previously, in which the query 672 returns 1,000 time series, and each time series includes 1,440 values (the average temperature per minute for each minute of a single day). In response to receiving the results of this query 672, the system calculates a single average value 680 for each time series 676. Thus, 1,000 average values would be calculated in this example, one average value 680 for each time series 676. The average value 680 calculated for a particular time series 676 represents the average of the 1,440 values within that time series 676.

Thus, the system calculates an average value 680 for each time series 676. In other words, the system calculates the average value 680 of all cells in a single time series 676 (or row 358), and the system does this for each time series 676 in the set of time series 676. As discussed above, a time series 676 corresponds to a row 358 of a heatmap 648, which includes multiple cells. Each cell holds the aggregate(measure) value 678 corresponding to a particular key property 664 and a particular time interval.

After calculating an average value 680 for each time series 676 in the set of time series 676, the system then orders the set of time series 676 vertically in the heatmap 648 based on the average values 680 that have been calculated for the time series 676. In other words, the vertical position of a particular time series 676 in the heatmap 646 depends on the average value 680 that is calculated for that time series 676. For example, the time series 676 may be ordered from the highest average value 680a to the lowest average value 680z. Each average value 680 is associated with a particular time series 676, which is identified by a particular key property 664. FIG. 6C shows the highest average value 680a associated with a time series 676a that is uniquely identified by a key property 664a, the second highest average value 680b associated with another time series 676b that is uniquely identified by another key property 664b, and so on. FIG. 6C also shows the lowest average value 680z associated with a time series 676z that is uniquely identified by a key property 664z. The ordering of the time series 676 in the heatmap 648 may correspond to the ordering shown in FIG. 6C. Alternatively, the time series 676 may be ordered in the opposite manner, from the time series 676 with the lowest average value 680z to the time series 676 with the highest average value 680a.

Referring now to FIG. 6D, when the system renders the heatmap 648, the system orders the set of time series 676 vertically in the heatmap 648 based on the average values 680 that have been calculated for the time series 676. In the depicted example, colors 682a, 682b, . . . 682n representing the aggregate(measure) values 678a, 678b, . . . 678n in the time series 676a having the highest average value 680a are located in the first (top) row of the heatmap 648, along with the key property 664a for that time series 676a. Colors 684a, 684b, . . . 684n representing the aggregate(measure) values 678a, 678b, . . . 678n in the time series 676b having the second highest average value 680b are located in the second row of the heatmap 648, along with the key property 664b for that time series 676b. Colors 686a, 686b, . . . 686n representing the aggregate(measure) values 678a, 678b, . . . 678n in the time series 676z having the lowest average value 680z are located in the last (bottom) row of the heatmap 648, along with the key property 664z for that time series 676z.

Alternatively, the system may order the time series 676 in the opposite manner. That is, the time series 676 may be ordered so that the time series 676z having the lowest average value 680z is positioned at the top (i.e., the first row of the heatmap 648), and the time series 676a having the highest average value 680a is positioned at the bottom (i.e., the last row of the heatmap 648).

In some embodiments, some or all of the operations described above (such as rendering the heatmap 648, calculating average values 680, and ordering the time series 676 in the heatmap 648 based on the average values 680) may be performed by the client 620. In alternative embodiments, some or all of these operations may be performed by a server (e.g., the DMS 604). In the above discussion, the term “system” has been used to indicate that this functionality can be performed by a client 620, by a server, or partially by a client 620 and partially by a server.

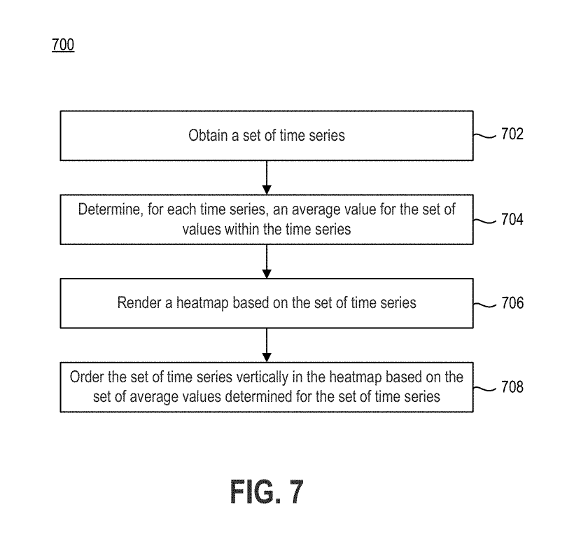

FIG. 7 is a flow diagram that illustrates an example of a method 700 for improving the readability of a heatmap 648 in accordance with the present disclosure. For the sake of clarity, the method 700 will be discussed in relation to the example shown in FIGS. 6A-D.

In accordance with the method 700, a set of time series 676 may be obtained 702. For example, as shown in the example of FIGS. 6A-D, user input 662 specifying various parameters (e.g., a key property 664, a measure property 666, an aggregate function 668, and an interval size 670) may be received. A query 672 that includes these parameters may be run against events 624 in a data store 618. The results of the query 672 may include a set of time series 676.

As discussed above, each time series 676 within the set of time series 676 may be associated with a key property 664 and may include a set of values 678. The set of values 678 may include the results of performing an aggregate function 668 with respect to a measure property 666 in events 624 that are associated with the key property 664, and at time intervals having the specified interval size 670.

The method 700 may also include determining 704, for each time series 676, an average value 680 for the set of values 678 within the time series 676. Thus, a set of average values 680 may be determined for the set of time series 676 (one average value 680 per time series 676).

A heatmap 648 may be rendered 706 based on the set of time series 676. The set of time series 676 may be ordered 708 vertically in the heatmap 648 based on the average values 680 that were determined for the set of time series 676. For example, the set of time series 676 may be ordered in descending order from the time series 676a having the highest average value 680a to the time series 676z having the lowest average value 680z. Alternatively, the set of time series 676 may be ordered in ascending order from the time series 676z having the lowest average value 680z to the time series 676a having the highest average value 680a.

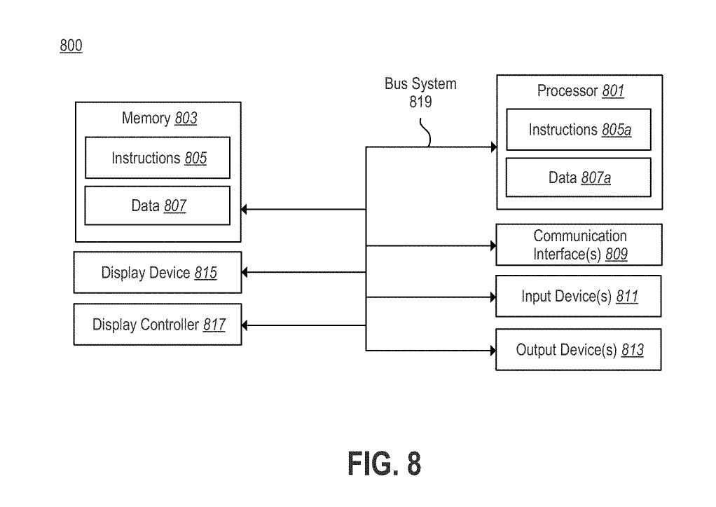

FIG. 8 illustrates certain components that may be included within a computer system 800. One or more computer systems 800 may be used to implement a user device 122 and/or a DMS 104 as disclosed herein.

The computer system 800 includes a processor 801. The processor 801 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the methods disclosed herein. Executing the instructions 805 may involve the use of the data 807 that is stored in the memory 803. When the processor 801 executes the instructions 805, various portions of the instructions 805a may be loaded onto the processor 801, and various pieces of data 807a may be loaded onto the processor 801.

Any of the various examples of modules and components described herein (e.g., the ingestion and storage components 112, the analytics components 114, the visualization components 116) may be implemented, partially or wholly, as instructions 805 stored in memory 803 and executed by the processor 801. Any of the various examples of data described herein (e.g., the events 124, the table 240, the query 672, the time series 676, the aggregate(measure) values 678, the average values 680) may be among the data 807 that is stored in memory 803 and used during execution of the instructions 805 by the processor 801.

A computer system 800 may also include one or more communication interfaces 809 for communicating with other electronic devices. The communication interfaces 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker, printer, etc. One specific type of output device that is typically included in a computer system is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for improving readability of a heatmap representing time series data, the method being implemented by a computer system comprising one or more processors, the method comprising:
obtaining a set of time series, each time series being associated with a key property and comprising a set of values, the set of values in a time series comprising results of performing an aggregate function with respect to a measure property in events that are associated with the key property, and at time intervals having an interval size;
determining, for each time series, an average value for the set of values within the time series, such that a set of average values is determined for the set of time series;
rendering a heatmap based on the set of time series; and
ordering the set of time series vertically in the heatmap based on the set of average values that is determined for the set of time series.

2. The method of claim 1, further comprising providing a query that comprises the key property, the measure property, the aggregate function, and the interval size, wherein the set of time series is received in response to the query.

3. The method of claim 2, wherein the query further comprises a filter.

4. The method of claim 2, further comprising receiving user input comprising the key property, the measure property, the aggregate function, and the time interval.

5. The method of claim 1, wherein:
the heatmap comprises multiple rows, multiple columns, and multiple cells, each cell corresponding to an intersection of a row and a column;
each row of the heatmap corresponds to a particular time series;
each column of the heatmap corresponds to a particular time interval; and
a color of a cell in the heatmap is based on a result of performing the aggregate function with respect to the measure property in the events that are associated with the key property and that have a timestamp within a time interval of the cell.

6. The method of claim 1, wherein:
a single average value is calculated for each time series, the single average value being calculated across the set of values in the time series comprising the results of performing the aggregate function with respect to the measure property in the events that are associated with the key property, and at the time intervals having the interval size; and
a vertical position of each time series in the heatmap depends on the average value that is calculated for the time series.

7. The method of claim 1, wherein the set of time series is ordered in the heatmap in descending order from a time series having a highest average value to a time series having a lowest average value.

8. The method of claim 1, wherein the set of time series is ordered in the heatmap in ascending order from a time series having a lowest average value to a time series having a highest average value.

9. The method of claim 1, wherein:
the set of time series comprises multiple time series; and
each time series within the set of multiple time series is associated with a unique value for the key property.

10. A computer system for improving readability of a heatmap representing time series data, comprising:
one or more processors; and
memory comprising instructions that are executable by the one or more processors to perform operations comprising:
obtaining a set of time series, each time series being associated with a key property and comprising a set of values, the set of values in a time series comprising results of performing an aggregate function with respect to a measure property in events that are associated with the key property, and at time intervals having an interval size;
determining, for each time series, an average value for the set of values within the time series, such that a set of average values is determined for the set of time series;
rendering a heatmap based on the set of time series; and
ordering the set of time series vertically in the heatmap based on the set of average values that is determined for the set of time series.

11. The computer system of claim 10, wherein the operations further comprise providing a query that comprises the key property, the measure property, the aggregate function, and the interval size, and wherein the set of time series is received in response to the query.

12. The computer system of claim 11, wherein the query further comprises a filter.

13. The computer system of claim 11, wherein the operations further comprise receiving user input comprising the key property, the measure property, the aggregate function, and the time interval.

14. The computer system of claim 10, wherein:
the heatmap comprises multiple rows, multiple columns, and multiple cells, each cell corresponding to an intersection of a row and a column;
each row of the heatmap corresponds to a particular time series;
each column of the heatmap corresponds to a particular time interval; and
a color of a cell in the heatmap is based on a result of performing the aggregate function with respect to the measure property in the events that are associated with the key property and that have a timestamp within a time interval of the cell.

15. The computer system of claim 10, wherein:
a single average value is calculated for each time series, the single average value being calculated across the set of values in the time series comprising the results of performing the aggregate function with respect to the measure property in the events that are associated with the key property, and at the time intervals having the interval size; and
a vertical position of each time series in the heatmap depends on the average value that is calculated for the time series.

16. The computer system of claim 10, wherein the set of time series is ordered in the heatmap in descending order from a time series having a highest average value to a time series having a lowest average value.

17. The computer system of claim 10, wherein the set of time series is ordered in the heatmap in ascending order from a time series having a lowest average value to a time series having a highest average value.

18. The computer system of claim 10, wherein:
the set of time series comprises multiple time series; and
each time series within the set of multiple time series is associated with a unique value for the key property.

19. A computer-readable medium having computer-executable instructions stored thereon that, when executed, cause one or more processors to perform operations comprising:
obtaining a set of time series, each time series being associated with a key property and comprising a set of values, the set of values in a time series comprising results of performing an aggregate function with respect to a measure property in events that are associated with the key property, and at time intervals having an interval size;
determining, for each time series, an average value for the set of values within the time series, such that a set of average values is determined for the set of time series;
rendering a heatmap based on the set of time series; and
ordering the set of time series vertically in the heatmap based on the set of average values that is determined for the set of time series.

20. The computer-readable medium of claim 19, wherein the operations further comprise providing a query that comprises the key property, the measure property, the aggregate function, and the interval size, and wherein the set of time series is received in response to the query.
